(19) United States
(12) Patent Application Publication
(10) Pub. No.: US 2025/0321648 A1
(43) Pub. Date: Oct. 16, 2025

(54) BUTTON STRUCTURE OF PROJECTED CAPACITIVE TOUCH PANEL

(71) Applicant: Silicon Integrated Systems Corp., Hsinchu (TW)

(72) Inventors: Wei-en SHIH, Hsinchu (TW); Ping-sen TUNG, Hsinchu (TW); Min-han LEE, Hsinchu (TW)

(73) Assignee: Silicon Integrated Systems Corp., Hsinchu (TW)

(21) Appl. No.: 19/176,185

(22) Filed: Apr. 11, 2025

(30) Foreign Application Priority Data
Apr. 12, 2024 (TW) 113113752

(51) Int. Cl. G06F 3/02; G06F 3/044

(52) U.S. Cl. CPC G06F 3/0202; G06F 3/044

(57) ABSTRACT

A button structure of projected capacitive touch panel disposed on a touch screen, wherein the button structure of projected capacitive touch panel includes: a button body disposed on the touch screen; a capacitive touch sheet disposed on the touch screen and positioned inside the button body; a conductive rubber disposed inside the button body, wherein the conductive rubber includes a contact portion which can contact the capacitive touch sheet; a button cap including a connecting body and a cover body, wherein the connecting body is disposed on the conductive rubber, and wherein the cover body protrudes out of the button body. The contact portion contacts the capacitive touch sheet when the button cap is pressed down, which causes the touch screen to generate an input signal by conducting the conductive rubber with the capacitive touch sheet.

### CROSS REFERENCE TO RELATED APPLICATIONS

This application claims the benefit of priority of Taiwan Patent Application No. 113113752, filed on Apr. 12, 2024, the contents of which are incorporated by reference as if fully set forth herein in their entirety.

### FIELD OF INVENTION

The present application relates to a button structure of a projected capacitive touch panel, and more particularly to a button structure of projected capacitive touch panel that provides physical button feedback on a touch screen.

### BACKGROUND OF INVENTION

In the prior art, when adding a button to a panel, it is often necessary to produce a mold for the button addition location according to a structure of the button addition location, and to set up a circuit accordingly before adding the new button. Therefore, the cost of adding buttons remains high, and the applications of the panel also limit the types of buttons that can be added.

Furthermore, existing buttons often need to be equipped with multiple layers of sensing film layers in order to successfully sense the input signal generated by the button being pressed. The design of the multiple layers of sensing film layers will cause complex changes in sensing capacitance. Therefore, a judgment of whether the button is pressed is easily to become inaccurate.

In view of this, it is necessary to provide a button structure of projected capacitive touch panel to solve the above technical problems.

### SUMMARY OF INVENTION

In order to solve the above-mentioned problems of the prior art, the purpose of the present application is to provide a button structure of projected capacitive touch panel, which can make the additional panel buttons not limited by the applications of the panel and can improve the accuracy of the signal detection and signal output of the buttons.

In a first aspect, the present application provides a button structure of projected capacitive touch panel disposed on a touch screen, including: a button body disposed on the touch screen; a capacitive touch sheet disposed on the touch screen and positioned inside the button body; a conductive rubber disposed inside the button body, wherein the conductive rubber includes a contact portion which can contact the capacitive touch sheet; and a button cap including a connecting body and a cover body, wherein the connecting body is disposed on the conductive rubber, and wherein the cover body protrudes out of the button body; wherein the contact portion contacts the capacitive touch sheet when the button cap is pressed down, and wherein the conductive rubber and the capacitive touch sheet are conducted to generate an input signal to the touch screen.

In some embodiments of the present application, a top of the button body includes an accommodation space, and wherein a top of the conductive rubber is positioned in the accommodation space when the conductive rubber is in a stretched state.

In some embodiments of the present application, when the contact portion contacts the capacitive touch sheet, the connecting body protrudes downward out of the accommodation space, and the top of the button body is accommodated in the cover body.

In some embodiments of the present application, a portion of the connecting body protrudes out of the accommodating space when the conductive rubber is in the stretched state.

In some embodiments of the present application, a slide rail structure is disposed between the button cap and the button body, and wherein the button cap moves up and down along the slide rail structure.

In some embodiments of the present application, the slide rail structure includes at least one track and at least one main body, and wherein the track and the body are arranged on the connecting body and in an accommodating space on the top portion of the button body, respectively.

In some embodiments of the present application, a rubber mounting portion disposed on the touch screen and surrounding the capacitive touch sheet, wherein a bottom portion of the conductive rubber is disposed on the rubber mounting portion.

In some embodiments of the present application, the conductive rubber is squeezed to form a compression protrusion to contact a compression contact portion on an inner wall of the button body when the contact portion contacts the capacitive touch sheet.

In some embodiments of the present application, the conductive rubber includes a stretched edge portion in a stretched state to contact a stretched contact portion on an inner wall of the button body.

In some embodiments of the present application, the button body is a hollow semi-conical structure, and wherein the conductive rubber is disposed on a bottom portion of the button body, and wherein the bottom portion of the button body surrounds the capacitive touch sheet and contacts the touch screen.

Compared with the prior art, the present application provides a button structure of projected capacitive touch panel, which is provided with a capacitive touch sheet and a conductive rubber between a touch screen and a button cap, and generates an input signal to the touch screen by conducting the conductive rubber and the capacitive touch sheet, and provides physical tactile feedback on the touch screen by using a simplified button element, and enables the output signal to be accurately identified, while solving the technical problem of easy misjudgment in determining whether a key is pressed.

The following is a detailed description of the specific embodiments in conjunction with the attached figures, which will make it easier to understand the purpose, technical content, characteristics and effects achieved by the present application.

### DESCRIPTION OF FIGURES

FIG. 1 is a schematic diagram showing an exploded view of a button structure of a projected capacitive touch panel according to one embodiment of the present application.

FIG. 2 is a schematic diagram showing a stretched state of the button structure of a projected capacitive touch panel according to one embodiment of the present application.

FIG. 3 is a schematic diagram showing a half-pressed state of a button structure of a projected capacitive touch panel according to one embodiment of the present application.

FIG. 4 is a schematic diagram showing a pressed state of a button structure of a projected capacitive touch panel according to one embodiment of the present application.

FIG. 5 is a schematic diagram showing a pressed state of a button structure of a projected capacitive touch panel according to yet another embodiment of the present application.

### DETAILED DESCRIPTION OF PREFERRED EMBODIMENTS

The technical solutions in the embodiments of the present application will be described clearly and completely below in conjunction with the figures in the embodiments of the present application. Obviously, the described embodiments are only part of the embodiments of the present application, rather than all of the embodiments. In addition, it should be understood that the specific embodiments described herein are only used to illustrate and explain the present application, and are not used to limit the present application. Referring to the figures, wherein like reference numerals represent like elements.

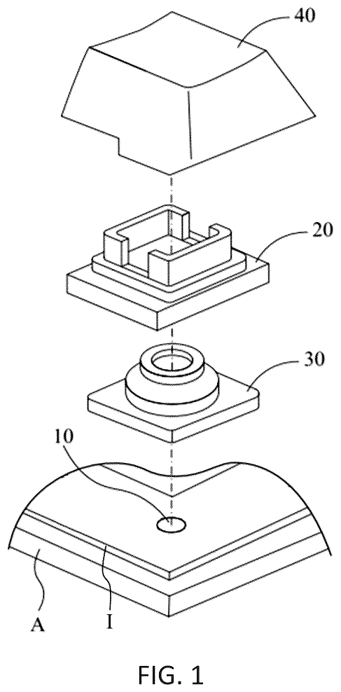

First, refer to FIG. 1, the button structure of the projected capacitive touch panel provided in the present application is composed of a capacitive touch sheet 10, a button body 20, a conductive rubber 30, and a button cap 40. By combining the button body 20 with the conductive rubber 30, the button structure of the projected capacitive touch panel provided by the present application can provide the user with same tactile feedback as a physical button without the need for an additional socket spring. Furthermore, since this button structure does not require a guide sleeve, the button body 20 and the button cap 40 are directly used to move up and down through the conductive rubber 30, and therefore, there is no need to add a silent ring to achieve the technical effect of silent and low structural loss. The detailed features of the button structure of the projected capacitive touch panel provided by the present application are disclosed in the following.

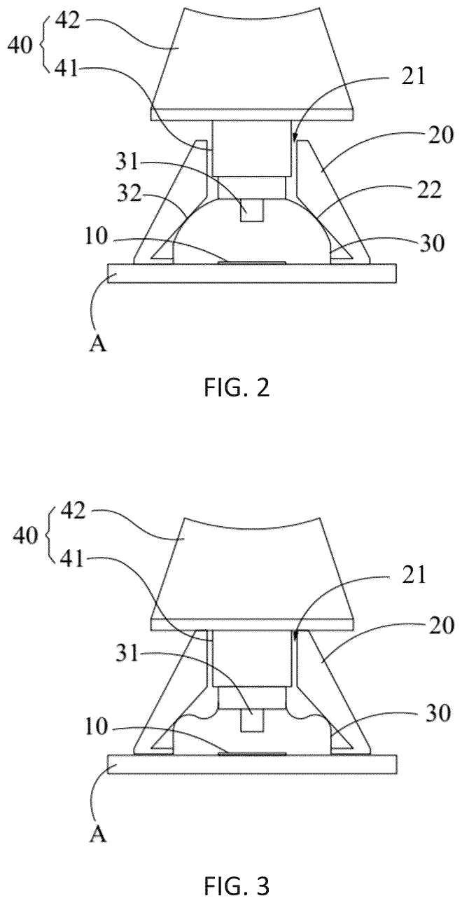

Refer to FIG. 2 to FIG. 4, they are cross-sectional views of the button structure of the projected capacitive touch panel of the present application in an unpressed state, a half-pressed state, and a full-pressed state, respectively.

As shown in FIG. 2, the button structure of the projected capacitive touch panel provided by the present application is disposed on the touch screen A, and includes: a button body 20 disposed on the touch screen A; a capacitive touch sheet 10 disposed on the touch screen A and positioned inside the button body 20; a conductive rubber 30 disposed inside the button body 20, and a contact portion 31 is provided on a top portion of the conductive rubber 30 close to the capacitive touch sheet 10. The contact portion 31 can contact the capacitive touch sheet 10 when the conductive rubber 30 is pressed; a button cap 40 including a connecting body 41 and a cover body 42. The connecting body 41 is disposed on the conductive rubber 30, and the cover body 42 protrudes out of the button body 20. The contact portion 31 contacts the capacitive touch sheet 10 when the button cap 40 is pressed down. The conductive rubber 30 and the capacitive touch sheet 10 are connected to generate an input signal to the touch screen A.

In some embodiments of the present application, the button body 20 is of a semi-conical shape, and its interior is hollow to accommodate the conductive rubber 30, and an accommodating space 21 for the conductive rubber 30 and the button cap 40 to move up and down is also provided between the top portion and the hollow region interior of the button body 20. The accommodating space 21 communicates with the outside of the button body 20 and the space accommodating the conductive rubber 30. A top portion of the conductive rubber 30 is positioned in the accommodation space 21 when the conductive rubber 30 is in a stretched state.

The conductive rubber 30 of the present application includes a rubber material and a conductive material. The rubber material is used to enable the conductive rubber 30 to withstand multiple up-and-down deformations and have excellent elasticity and wear resistance, so that the conductive rubber 30 can push back the button cap 40 and resist the button body 20. The rubber material includes Ethylene Propylene Diene Monomer (EPDM), Ethylene Acrylic Elastomer (AEM), Styrene-Butadiene Rubber (SBR), Isobutylene Isoprene Rubber (IIR), Nitrile Butadiene Rubber (NBR), Natural Rubber (NR), Silicone, Fluoroelastomer Kautschuk Material (FKM), Fluoroelastomer Polymer Material (FPM), VITON, Hydrogenated nitrile rubber (HNBR), Chloroprene rubber (CR), Carboxylated Nitrile Butadiene Rubber (XNBR), Acrylic Rubber (ACM), Polyester Urethane (AU), Polyether Urethane (EU), CO (Epichlorohydrin) (ECO).

The conductive material is used to make the conductive rubber 30 have good conductivity, so that when the conductive rubber 30 contacts the capacitive touch sheet 10, the touch screen A can receive the output signal output by the button structure. The conductive material includes carbon black, carbon nanotubes (CNTs), metal powder, or the conductive material may be particles containing both conductive polymer and metal powder.

In some embodiments provided in the present application, the conductive material is evenly distributed in the conductive rubber 30. Alternatively, in some other embodiments provided by the present application, the conductive material of the contact portion 31 is distributed more densely than other regions of the conductive rubber 30, so as to improve the conductivity of the conductor formed when the conductive rubber 30 contacts the capacitive touch sheet 10.

In one embodiment provided in the present application, when the contact portion 31 contacts the capacitive touch sheet 10, the connecting body 41 protrudes downward out of the accommodating space 21. Alternatively, in another embodiment provided in the present application, when the contact portion 31 contacts the capacitive touch sheet 10, the connecting body 41 protrudes downward out of the accommodating space 21, and at this time, the top portion of the button body 20 is accommodated in the cover body 42 to stabilize the relative position relationship between the connecting body 41 and the button body 20. Alternatively, in another embodiment provided by the present application, a ratio of the length of the accommodating space 21 to the length of the connecting body 41 ranges between 1:2 and 1:1, so as to maintain the stability of the button cap 40 and the conductive rubber 30 in movement relative to the button body 20.

In one embodiment provided in the present application, a slide rail structure is disposed between the button cap 40 and the button body 20. The button cap 40 moves up and down along the slide rail structure. The track and the main body of the slide rail structure are separately arranged on the button cap 40 and the button body 20, and the button cap 40 and the button body 20 move within a predetermined relative range in the accommodating space 21 to form the slide rail structure.

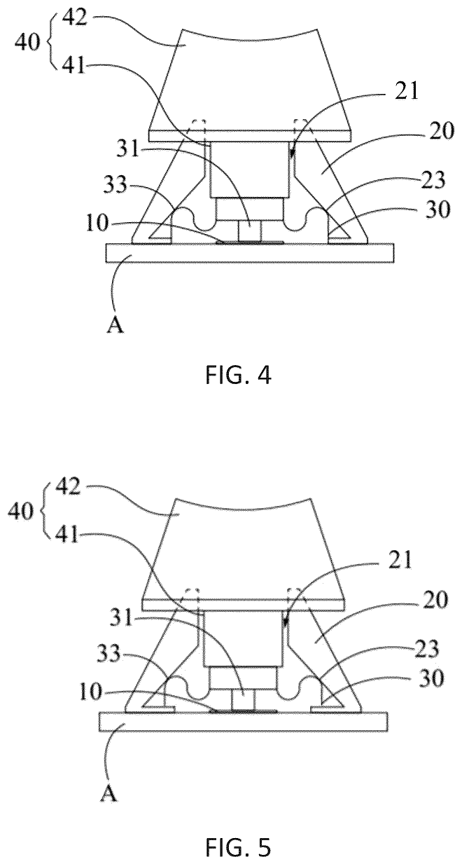

In another embodiment provided in the present application, the slide rail structure includes at least one track and at least one body, and the track and the body are arranged on the connecting body 41 and in the accommodating space 21 on the top portion of the button body 20, respectively. Therefore, the button structure provided by the present application can push the button cap 40 to slide upward along the slide rail structure through the deformation recovery force of the conductive rubber 30 after being compressed, and recover from the full-stroke pressed state disclosed in FIG. 4 to the unpressed state disclosed in FIG. 2.

Please refer to FIG. 2, a portion of the connecting body 41 protrudes out of the accommodating space 21 when the conductive rubber 30 is in the stretched state. At this time, there is still a spacing distance between the cover body 42 and the accommodating space 21 to provide a longer button pressing stroke, so as to provide the user with significant physical button feedback.

In another embodiment provided by the present application, the button structure provided by the present application further includes a rubber mounting portion I disposed on the touch screen A. The rubber mounting portion I surrounds the capacitive touch sheet 10, and a bottom portion of the conductive rubber 30 is disposed on the rubber mounting portion I. By setting the rubber mounting portion I in the button structure provided in the present application, a more stable button structure is provided.

In yet another embodiment provided by the present application, a stretched edge portion 32 of the conductive rubber 30 contacts a stretched contact portion 22 on an inner side wall of the button body 20 when the conductive rubber 30 is in the stretched state. Therefore, the conductive rubber 30 can be pushed against by the stretched contact portion 22 to stabilize the button cap 40 without shaking in parallel when the button is in the stretched state.

Alternatively, in another embodiment of the present application, the button body 20 is a square connecting body structure as shown in FIG. 1, and the conductive rubber 30 includes a square base and can be accommodated in the button body 20. In this embodiment, the conductive rubber 30 is configured to include a pot-shaped body with different circular radii at different height positions, wherein the circular radius of the top of the conductive rubber 30 is smaller than the circular radius of the bottom of the pot-shaped body, and the connecting body of the button cap 40 contacts the top portion of the conductive rubber 30, and similarly, a deformation force and restoring force of the conductive rubber 30 push the button cap 40 up and down. Since the conductive rubber 30 in this embodiment is a pot-shaped structure, when the button cap 40 is pressed down, the radius of the circle on the pot body side of the conductive rubber 30 is longer and the protrusion variable when pressed is smaller. Therefore, at this time, the button body 20 is subjected to less force from the conductive rubber 30, and the conductive rubber 30 can have a longer service life. In addition, in this embodiment, the bottom portion of the conductive rubber 30 is configured as a square bottom that matches the button body 20, and the bottom portion of the conductive rubber 30 is set on the bottom portion of the button body 20, so that the bottom portion of the button body 20 can be used to stabilize the structure of the button body 20 and the conductive rubber 30. Alternatively, the bottom portion of the conductive rubber 30 is configured as a square bottom that matches the button body 20, wherein the bottom portion of the conductive rubber 30 contacts the touch screen A, and a button region with a changed capacitance value is formed on the touch screen A by the placement portion of the conductive rubber 30, so that the touch screen A can distinguish a setting range of the button structure more clearly.

Please refer to FIG. 4, in another embodiment provided by the present application, when the contact portion 31 contacts the capacitive touch sheet 10, a compression protrusion 33 formed by squeezing the conductive rubber 30 contacts a compression contact portion 23 on an inner wall of the button body 20. In another embodiment provided in the present application, a thickness of the compression contact portion 23 is smaller than a thickness of other parts of the button body 20. Therefore, a space for accommodating the compression contact portion 23 is formed on an inner side of the button body 20 to enhance the pressing stability of the button structure.

In another embodiment provided in the present application, when the button body 20 is a semi-conical body, the stretched contact portion 22 on the inner side wall of the button body 20 is higher than the compression contact portion 23. Therefore, a stress point for stabilizing the horizontal position of the button cap 40 is positioned closer to the button cap 40 when the button structure is in a stretched state. The accommodating compression contact portion 23 is positioned closer to the capacitive touch sheet 10 when the contact portion 31 contacts the capacitive touch sheet 10. Therefore, the stability of the button structure provided by the present application can be further improved.

Alternatively, refer to FIG. 5, another embodiment of the present application is disclosed, wherein the button body 20 is a hollow semi-conical structure, the conductive rubber 30 is disposed on the bottom portion of the button body 20, and the bottom portion of the button body 20 surrounds the capacitive touch sheet 10 and contacts the touch screen A. In this embodiment, since a conductivity of the button body 20 is less than a conductivity of the conductive rubber 30, and the conductive rubber 30 only contacts the button body 20 and does not contact the touch screen A, when the conductive rubber 30 is actuated by force, it will not cause the capacitance of the touch screen A to change, thereby improving an accuracy of the output signal of the button structure.

It should be further explained that since the button structure of the projected capacitive touch panel provided in the present application can be directly placed on the touch screen A by placing the capacitive touch sheet 10, the button body 20, the conductive rubber 30, and the button cap 40, the applications of the additional buttons will no longer be limited by the mold and matching circuit like the buttons of the traditional panel. For example, the button structure of the projected capacitive touch panel provided in the present application can be directly mounted on advertising panels, car dashboards, tablet computers, or panels in different applications such as washing machines and ATM interfaces, without the need to modify the sensing circuit in the panel and the external mold to complete the button addition.

The present application has at least the following beneficial effects. The present application provides a button structure of projected capacitive touch panel, which generates an input signal to the touch screen by setting a capacitive touch sheet and a conductive rubber between the touch screen and the cap, and generates a physical tactile feedback on the touch screen by connecting the conductive rubber and the capacitive touch sheet, and achieves the technical effect of providing accurate identification of the output signal and solving the technical problem of easily misjudging whether the button is pressed.

It should be noted that the combination of the various elements in the present application preferably forms the above-mentioned multiple embodiments, but this should not be interpreted as a limitation on the present application. That is, the various elements in the present application can also have more combinations and are not limited to the above-mentioned multiple embodiments.

Specific examples are used herein to illustrate the principles and implementation methods of the present application. The description of the above embodiments is only used to help understand the technical solution and core idea of the present application. Those skilled in the art should understand that they can still modify the technical solutions described in the aforementioned embodiments, or make equivalent replacements for some of the technical features therein, and these modifications or replacements do not make the essence of the corresponding technical solutions deviate from a scope of the technical solutions of the embodiments of the present application.

What is claimed is:

1. A button structure of projected capacitive touch panel disposed on a touch screen, comprising:
a button body disposed on the touch screen;
a capacitive touch sheet disposed on the touch screen and positioned inside the button body;
a conductive rubber disposed inside the button body, wherein the conductive rubber comprises a contact portion which can contact the capacitive touch sheet; and
a button cap comprising a connecting body and a cover body, wherein the connecting body is disposed on the conductive rubber, and wherein the cover body protrudes out of the button body;
wherein the contact portion contacts the capacitive touch sheet when the button cap is pressed down, and wherein the conductive rubber and the capacitive touch sheet are conducted to generate an input signal to the touch screen.

2. The button structure of projected capacitive touch panel of claim 1, wherein a top of the button body comprises an accommodation space, and wherein a top of the conductive rubber is positioned in the accommodation space when the conductive rubber is in a stretched state.

3. The button structure of projected capacitive touch panel of claim 2, wherein when the contact portion contacts the capacitive touch sheet, the connecting body protrudes downward out of the accommodation space, and the top of the button body is accommodated in the cover body.

4. The button structure of projected capacitive touch panel of claim 2, wherein a portion of the connecting body protrudes out of the accommodating space when the conductive rubber is in the stretched state.

5. The button structure of projected capacitive touch panel of claim 1, wherein a slide rail structure is disposed between the button cap and the button body, and wherein the button cap moves up and down along the slide rail structure.

6. The button structure of projected capacitive touch panel of claim 5, wherein the slide rail structure comprises at least one track and at least one main body, and wherein the track and the main body are arranged on the connecting body and in an accommodating space on the top portion of the button body, respectively.

7. The button structure of projected capacitive touch panel of claim 1, further comprising a rubber mounting portion disposed on the touch screen and surrounding the capacitive touch sheet, wherein a bottom portion of the conductive rubber is disposed on the rubber mounting portion.

8. The button structure of projected capacitive touch panel of claim 1, wherein the conductive rubber is squeezed to form a compression protrusion to contact a compression contact portion on an inner wall of the button body when the contact portion contacts the capacitive touch sheet.

9. The button structure of projected capacitive touch panel of claim 1, wherein the conductive rubber comprises a stretched edge portion in a stretched state to contact a stretched contact portion on an inner wall of the button body.

10. The button structure of projected capacitive touch panel of claim 1, wherein the button body is a hollow semi-conical structure, and wherein the conductive rubber is disposed on a bottom portion of the button body, and wherein the bottom portion of the button body surrounds the capacitive touch sheet and contacts the touch screen.
